(19) United States
(12) Patent Application Publication
(10) Pub. No.: US 2014/0028618 A1
(43) Pub. Date: Jan. 30, 2014

(54) TOUCH APPARATUS

(71) Applicants: Ting-Yu Chang, Kaohsiung County (TW); Ching-Fu Hsu, Taichung City (TW); Chong-Wei Li, Changhua County (TW); Kuang-Wei Li, Taichung City (TW)

(72) Inventors: Ting-Yu Chang, Kaohsiung County (TW); Ching-Fu Hsu, Taichung City (TW); Chong-Wei Li, Changhua County (TW); Kuang-Wei Li, Taichung City (TW)

(73) Assignees: WINTEK CORPORATION, Taichung City (TW); WINTEK (CHINA) TECHNOLOGY LTD., Guangdong Province (CN)

(21) Appl. No.: 13/950,308

(22) Filed: Jul. 25, 2013

(30) Foreign Application Priority Data
Jul. 25, 2012 (TW) 101126796

(51) Int. Cl. G06F 3/044

(52) U.S. Cl. CPC G06F 3/044
USPC 345/174

(57) ABSTRACT

A touch apparatus including a touch panel, a sensing controller and a capacitance matching unit is provided. The touch panel has a plurality of scan ports and a plurality of sensing ports, wherein the touch panel outputs a plurality of sensing signals through the sensing ports. The sensing controller drives the touch panel through a plurality of scan lines correspondingly coupled to the scan ports, and receives the sensing signals through a plurality of sensing lines correspondingly coupled to the sensing ports. The capacitance matching unit is coupled between the touch panel and the sensing controller through the scan lines, and is used for tuning an equivalent capacitance of the touch panel.

### CROSS-REFERENCE TO RELATED APPLICATION

This application claims the priority benefit of taiwan application serial no. 101126796, filed on Jul. 25, 2012. The entirety of the above-mentioned patent application is hereby incorporated by reference herein and made a part of this specification.

### BACKGROUND

1. Technical Field

The invention relates to a touch apparatus. Particularly, the invention relates to a capacitive touch apparatus.

2. Related Art

In recent years, along with quick development and progress of wireless mobile communication and information home appliance, in order to achieve more convenience, more compact size and more intuitive operation to eliminate estrangement between human and computer devices, input devices of many information products have been changed from conventional keyboards and mice, etc. to touch panels. Since a projected capacitive touch panel has a better touch sensing effect, many manufacturers invest plenty of money to research and develop the related techniques.

Along with increasing demand of the user, a size of the touch panel becomes larger. However, as the size of the touch panel increases, the layout of internal wiring of the touch apparatus becomes longer. As the wiring becomes longer, a parasitic effect thereof results in a fact that the touch panel is hard to be driven.

A general solution is to change a structure layout of internal electrodes of the touch panel to achieve a purpose of decreasing a coupling capacitance, though efficiency of such method is limited as the size of the touch panel increases. Moreover, another solution is to increase signal driving capability of a sensor IC. Although such method can resolve the problem generated in driving the large size touch panel, comparatively, such method inevitably increases a whole power consumption of the touch apparatus.

### SUMMARY

The invention is directed to a touch apparatus, which is capable of mitigating a parasitic capacitance effect on a wiring, so that the touch apparatus is capable of driving a large size touch panel without additional power consumption.

The invention provides a touch apparatus including a touch panel, a sensing controller and a capacitance matching unit. The touch panel has a plurality of scan ports and a plurality of sensing ports, where the touch panel outputs a plurality of sensing signals through the sensing ports. The sensing controller drives the touch panel through a plurality of scan lines correspondingly coupled to the scan ports, and receives the sensing signals through a plurality of sensing lines correspondingly coupled to the sensing ports. The capacitance matching unit is coupled between the touch panel and the sensing controller through the scan lines, and is used for tuning an equivalent capacitance of the touch panel.

In an embodiment of the invention, the sensing controller includes a driving module and a sensing module. The driving module provides a driving signal, and sequentially outputs the driving signal to the touch panel through the scan lines. The sensing module receives the sensing signals through the sensing lines, and generates touch information of the touch panel according to the sensing signals.

In an embodiment of the invention, the capacitance matching unit includes a plurality of matching capacitors. Each of the matching capacitors has a first terminal and a second terminal, the first terminals of the matching capacitors are coupled to the sensing controller, and the second terminal of each of the matching capacitors is correspondingly coupled to one of the scan lines, where capacitances of the matching capacitors are determined by a size of the touch panel.

In an embodiment of the invention, the capacitance matching unit includes a matching capacitor and a multiplexer. The matching capacitor has a first terminal and a second terminal. The first terminal of the matching capacitor is coupled to the sensing controller. The multiplexer has an input and an output. The input of the multiplexer is coupled to the second terminal of the matching capacitor, and the output of the multiplexer is coupled to each of the scan lines. A capacitance of the matching capacitor is determined by a size of the touch panel, and the multiplexer couples the matching capacitor to one of the scan lines according to a multiplexing control signal, so that the driving signal is sequentially output to the touch panel through each of the scan lines coupled to the matching capacitor.

In an embodiment of the invention, the capacitance matching unit further includes a switch unit. The switch unit determines whether or not to couple the matching capacitor to the sensing controller according to a size selection signal. The switch unit includes a first switch and a second switch. The first switch has a first terminal and a second terminal. The first terminal of the first switch is coupled to the sensing controller, and the second terminal of the first switch is coupled to the first terminal of the matching capacitor. The second switch has a first terminal and a second terminal, the first terminal of the second switch is coupled to sensing controller and the first terminal of the first switch, and the second terminal of the second switch is coupled to the multiplexer and the second terminal of the matching capacitor. When the size of the touch panel is greater than a predetermined value, the first switch is turned on according to the size selection signal, and the second switch is turned off according to the size selection signal, and when the size of the touch panel is smaller than the predetermined value, the first switch is turned off according to the size selection signal, and the second switch is turned on according to the size selection signal.

The invention provides a touch apparatus including a touch panel and a sensing controller. The touch panel has a plurality of scan ports and a plurality of sensing ports, where the touch panel outputs a plurality of sensing signals through the sensing ports. The sensing controller drives the touch panel through a plurality of scan lines correspondingly coupled to the scan ports, and receives the sensing signals through a plurality of sensing lines correspondingly coupled to the sensing ports, where the sensing controller further tunes an equivalent capacitance of the touch panel.

In an embodiment of the invention, the sensing controller includes a capacitance matching unit. The capacitance matching unit is coupled to the touch panel through the scan lines, where the capacitance matching unit sequentially outputs a driving signal to the corresponding scan lines, and tunes the equivalent capacitance of the touch panel.

In an embodiment of the invention, the capacitance matching unit includes a matching capacitor and a multiplexer. The matching capacitor has a first terminal and a second terminal. The first terminal of the matching capacitor receives the driving signal. The multiplexer has an input and an output. The input of the multiplexer is coupled to the second terminal of the matching capacitor, and the output of the multiplexer is coupled to each of the scan lines. A capacitance of the matching capacitor is determined by a size of the touch panel, and the multiplexer couples the matching capacitor to one of the scan lines according to a multiplexing control signal, so that the driving signal is sequentially output to the touch panel through each of the scan lines coupled to the matching capacitor.

The invention provides a touch apparatus including a touch panel, a sensing controller and a capacitance matching unit. The touch panel has a plurality of driving sensing ports, where the touch panel outputs a plurality of sensing signals through the driving sensing ports. The sensing controller outputs a driving signal to drive the touch panel through a plurality of driving sensing lines coupled to the driving sensing ports, and receives the sensing signals through the driving sensing lines. The capacitance matching unit is coupled between the touch panel and the sensing controller through the driving sensing lines. The capacitance matching unit is used for tuning an equivalent capacitance of the touch panel.

In an embodiment of the invention, the capacitance matching unit includes a plurality of matching capacitors. Each of the matching capacitors has a first terminal and a second terminal, the first terminals of the matching capacitors are coupled to the sensing controller, and the second terminal of each of the matching capacitors is correspondingly coupled to one of the driving scan lines, where capacitances of the matching capacitors are determined by a size of the touch panel.

According to the above descriptions, in the touch apparatus of the present embodiment, the capacitance matching unit connected in series to the lines/paths is used to decease a parasitic capacitance effect between the touch panel and the sensing controller. Therefore, the sensing controller can drive a large size touch panel without changing driving capability of the driving signal.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a touch apparatus 100 according to an embodiment of the invention.

FIG. 2 is a schematic diagram of an equivalent circuit between a touch panel 110 and a sensing controller 120 of the embodiment of FIG. 1.

FIG. 3 is a schematic diagram of a touch apparatus 300 according to an embodiment of the invention.

FIG. 4 is a schematic diagram of a capacitance matching unit 430 according to an embodiment of the invention.

FIG. 5 is a schematic diagram of a touch apparatus 500 according to an embodiment of the invention.

FIG. 6 is a schematic diagram of a touch apparatus 600 according to an embodiment of the invention.

FIG. 7 is a schematic diagram of an equivalent circuit between a touch panel 610 and a sensing controller 620 of the embodiment of FIG. 6.

### DETAILED DESCRIPTION OF DISCLOSED EMBODIMENTS

An embodiment of the invention provides a touch apparatus, in which a capacitance matching unit coupled between the sensing controller and the touch panel is used to decrease a parasitic capacitance effect of wiring, so that the touch apparatus is capable of driving a large size touch panel without additional power consumption.

Reference will now be made in detail to the present preferred embodiments of the invention, examples of which are illustrated in the accompanying drawings. Wherever possible, the same reference numbers are used in the drawings and the description to refer to the same or like parts.

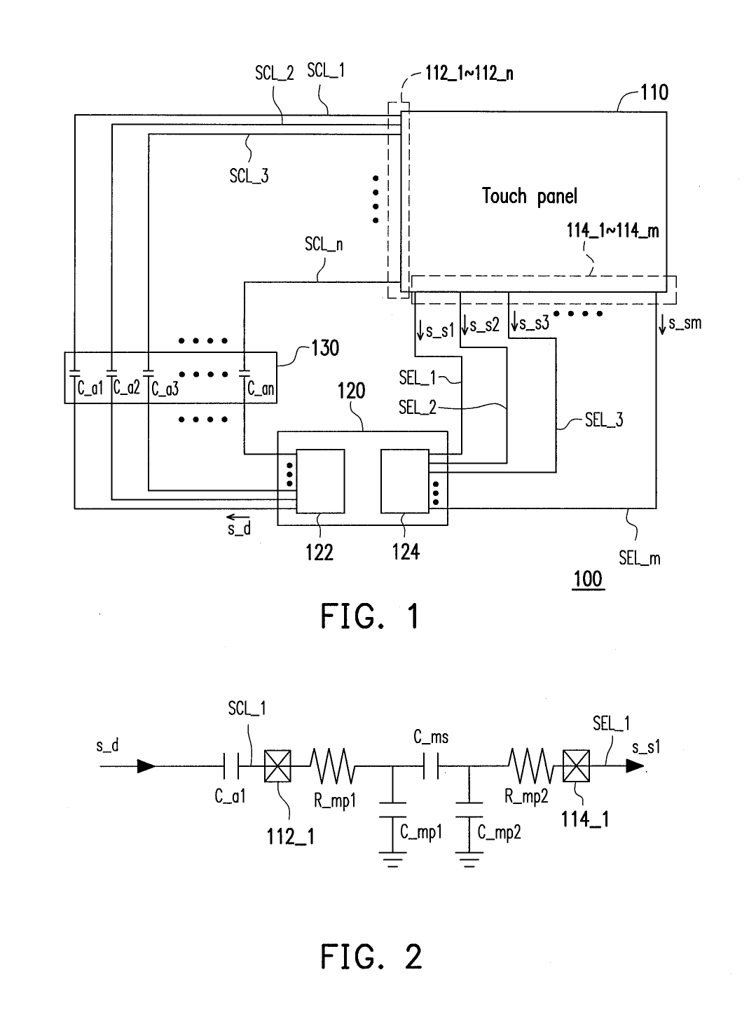

FIG. 1 is a schematic diagram of a touch apparatus 100 according to an embodiment of the invention. Referring to FIG. 1, the touch apparatus 100 includes a touch panel 110, a sensing controller 120 and a capacitance matching unit 130. The touch panel 110 has a plurality of scan ports 112_1-112_n and a plurality of sensing ports 114_1-114_m, where the touch panel 110 outputs a plurality of sensing signals s_s1-s_{—} sm through the sensing ports 114_1-114_m, and m and n are positive integers. The sensing controller 120 drives the touch panel 110 through a plurality of scan lines SCL_1-SCL_n correspondingly coupled to the scan ports 112_1-112_n, and receives the sensing signals s_s1-s_sm through a plurality of sensing lines SEL_1-SEL_m correspondingly coupled to the sensing ports 114_1-114_m. The capacitance matching unit 130 is coupled between the touch panel 110 and the sensing controller 120 through the scan lines SCL_1-SCL_n. The capacitance matching unit 130 is used for tuning an equivalent capacitance of the touch panel 110.

In the present embodiment, the touch panel 110 is, for example, a mutual capacitance touch panel, which outputs the sensing signals s_s1-s_sm by sensing a capacitance variation of each mutual capacitor between electrodes in the touch panel 110. The sensing controller 120 includes a driving module 122 and a sensing module 124. The driving module 122 provides a driving signal s_d for driving the touch panel 110, and sequentially outputs the driving signal s_d to the touch panel 110 through the scan lines SCL_1-SCL_n. The sensing module 124 receives the sensing signals s_s1-s_sm through the sensing lines SEL_1-SEL_m, and determines a touch operation of a user performed on the touch panel 110 according to the sensing signals s_s1-s_sm, for example, a touch position or a touch gesture, etc., and accordingly generates touch information of the touch panel 100.

Moreover, the capacitance matching unit 130 is, for example, composed of a plurality of matching capacitors C_a1-C_an. First terminals of the matching capacitors C_a1-C__an are coupled to the sensing controller 120, and second terminals of the matching capacitors C_a1-C_an are correspondingly coupled to the scan lines SCL_1-SCL_n, where the first terminals of the matching capacitors C_a1-C_an are coupled to the sensing controller 120 through a plurality of input ports (not shown) on the sensing controller 120. In other words, each of the matching capacitors C_a1-C_an is connected in series to one of the scan lines SCL_1-SCL_n. Each capacitance of the matching capacitors C_a1-C_an can be determined by a size of the touch panel 110, i.e. the capacitances of the matching capacitors C_a1-C_an are positively correlated to the size of the touch panel 110. For example, the greater the size of the touch panel 110 is, the greater the capacitances of the matching capacitors C_a1-C_an are; conversely, the smaller the size of the touch panel 110 is, the smaller the capacitances of the matching capacitors C_a1-C_an are; even more, when the size of the touch panel 110 is decreased to a predetermined size, it is unnecessary to use the matching capacitors C_a1-C_an (which is described later).

In detail, regarding the mutual capacitance touch panel 110, corresponding sensing channels in the touch panel 110 are detected by sequentially driven the scan lines SCL_1-SCL_n according to a predetermined clock signal, so that the sensing channels can sense capacitance variations between the electrodes, and the sensing signals s_s1-s_sm are output to the sensing ports 114_1-114m through readout channels in the touch panel 110. In other words, each of the scan lines SCL_1-SCL_n is coupled to a corresponding sensing channel in the touch panel 110 through the scan ports 112_1-112n, and each of the sensing lines SEL_1-SEL_m is coupled to a corresponding readout channel through the sensing ports 114_1-114_m.

Regarding a design of a general touch apparatus, the greater the size of the touch panel is, the longer the wiring of the touch panel is, and the longer wiring results in severe parasitic capacitance effect generated by an electrode pattern (not shown) in the touch panel 110. Regarding the touch apparatus 100, the capacitance of each mutual capacitor between the electrodes of the touch panel 110 is increased as the parasitic capacitances of the scan lines SCL_1-SCL_n and the sensing lines SEL_1-SEL_m are increased and the parasitic capacitance effect generated by the electrode patterns (not shown) in the touch panel 110 is increased, and the driving module 122 has to provide the driving signal s_d having larger driving capability to ensure the touch panel 110 normally sensing a touch operation of the user.

In order to provide the driving signal s_d having larger driving capability, more power is inevitably consumed. Therefore, the capacitance matching unit 130 of the present embodiment uses the matching capacitors C_a1-C_an to reduce the parasitic capacitances caused by wiring of the scan lines SCL_1-SCL_n between the touch panel 110 and the sensing controller 120 and reduce the influence of the parasitic capacitance effect generated by the electrode patterns (not shown) in the touch panel 110 through an effect of capacitors connected in series, such that the sensing controller 120 can drive a large size touch panel 110 without additional power consumption.

In detail, FIG. 2 is a schematic diagram of an equivalent circuit between the touch panel 110 and the sensing controller 120 of the embodiment of FIG. 1. Referring to FIG. 2, taking an equivalent circuit between the scan port 112_1 and the sensing port 114_1 as an example, in case that the capacitance matching unit 130 is not used, a circuit characteristic model between the touch panel 110 and the sensing controller 120 can be equivalent to a resistor R_mp1, a resistor R_mp2, a capacitor C_mp1, a capacitor C_mp2 and a capacitor C_ms. The resistor R_mp1 is an equivalent resistor of the scan port 112_1 (including a resistance of the electrode and a parasitic resistance of the scan line SCL_1), the capacitor C_mp1 is an equivalent capacitor of the scan port 112_1 relative to ground (including a capacitor of the electrode and a parasitic capacitor of the scan line SCL_1). The resistor R_mp2 is an equivalent resistor of the sensing port 114_1 (including a resistance of the electrode and a parasitic resistance of the sensing line SEL_1), the capacitor C_mp2 is an equivalent capacitor of the sensing port 114_1 relative to ground (including a capacitor of the electrode and a parasitic capacitor of the sensing line SEL_1). Moreover, the capacitor C_ms is, for example, a mutual capacitor between the scan port 112_1 and the sensing port 114_1 of the touch panel 110 (i.e. between the electrodes).

In detail, when the touch panel 110 is a large size capacitive touch panel, due to an influence of a wiring layout effect, the parasitic capacitance of the scan line SCL_1 and the parasitic capacitance effect generated by the electrode patterns (not shown) in the touch panel 110 results in a fact that a capacitance of the capacitor C_ms is rather large, for example, 100 pF, so that the touch panel 110 is hard to be driven. Therefore, in the present embodiment, the capacitance matching unit 130 is added. In FIG. 2, by adding the capacitance matching unit 130, the matching capacitor C_a1 is connected in series to the scan line SCL_1, which decreases the whole equivalent capacitance. For example, in case that the matching capacitor C_a1 is equal to the capacitance of the capacitor C_ms, and the capacitance of the matching capacitor C_a1 is about 50 pF (assuming the capacitor C_mp1 and the capacitor C_mp2 are far less than the capacitor C_ms), when the sensing controller 120 drives the touch panel 110, it is equivalent to drive the touch panel 110 with the capacitance of the mutual capacitor of 50 pF. Therefore, compared to a general touch apparatus, the touch apparatus 100 of the present embodiment can still drive the large size touch panel without changing the driving capability of the driving signal s_d. Moreover, since excessively large mutual capacitance results in a fact that the touch panel is hard to be driven, and excessively small mutual capacitance results in a fact that the sensing signals output by the touch panel are distorted, magnitudes of the matching capacitors C_a1-C_{—} an are required to be adjusted according to the size of the touch panel 110.

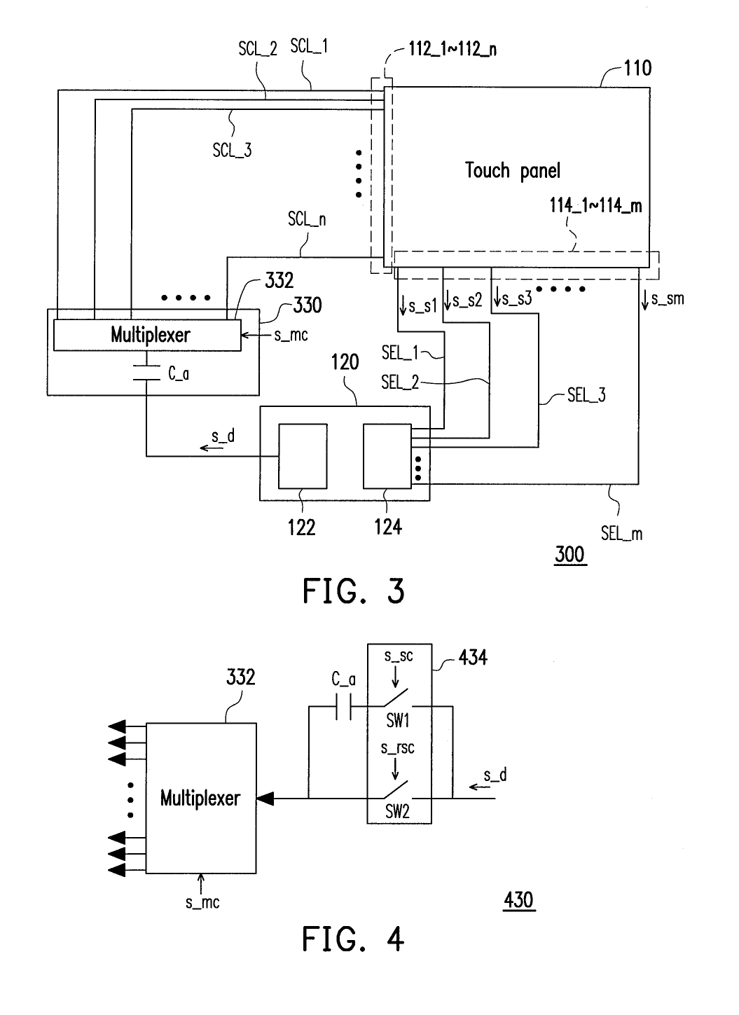

FIG. 3 is a schematic diagram of a touch apparatus 300 according to an embodiment of the invention. Referring to FIG. 3, the touch apparatus 300 includes the touch panel 110, the sensing controller 120 and a capacitance matching unit 330. The present embodiment is similar to the embodiment of FIG. 1, which also decreases the parasitic capacitance effect of wiring by connecting capacitors to the scan lines SCL_1-SCL_n in series. A difference between the present embodiment and the embodiment of FIG. 1 is that the capacitance matching unit 330 of the present embodiment further sequentially couples a single matching capacitor to the corresponding scan lines SCL_1-SCL_n according to an output sequence of the driving signal s_d through a manner of multiplexing.

In the present embodiment, the capacitance matching unit 330 includes a matching capacitor C_a and a multiplexer 332. The matching capacitor C_a has a first terminal and a second terminal, and the first terminal of the matching capacitor C_a is coupled to the sensing controller 120. The multiplexer 332 has an input and an output, where the input of the multiplexer 332 is coupled to the second terminal of the matching capacitor C_a, and the output of the multiplexer 332 is coupled to the scan lines SCL_1-SCL_n. Similarly, a capacitance of the matching capacitor C_a is tuned according to the size of the touch panel 110. Moreover, the multiplexer 332 couples the matching capacitor C_a to one of the scan lines SCL_1-SCL_n according to a multiplexing control signal s_mc, so that the driving signal s_d is selectively/sequentially output to the scan lines SCL_1-SCL_n through the matching capacitor.

In detail, after the driving module 122 outputs the driving signal s_d to the multiplexer 332 through the matching capacitor C_a, the multiplexer 332 sequentially outputs the driving signal s_d to the touch panel 110 through the scan lines SCL_1-SCL_n according to the multiplexing control signal s mc. In other words, the multiplexer 332 couples the matching capacitor C_a to the corresponding one of the scan lines SCL_1-SCL_n in accordance with a timing of outputting the driving signal s_d to the touch panel 110 according to the multiplexing control signal s mc.

When the driving signal s_d sequentially drives the touch panel 110 through each of the scan lines SCL_1-SCL_n the circuit characteristic model between the touch panel 110 and the sensing controller 120 can also be equivalent to the equivalent circuit schematic diagram of FIG. 2, so as to effectively decrease the parasitic capacitance effect on the wiring of the touch apparatus 300.

Moreover, the other operations of the touch apparatus 300 are the same to that of the touch apparatus 100 of FIG. 1, which are not repeated.

On the other hand, the capacitance matching unit 330 of FIG. 3 can also determine whether or not to couple the matching capacitor C_a to the corresponding scan lines SCL_1-SCL_n according to the size of the touch panel 110, as that shown in FIG. 4. FIG. 4 is a schematic diagram of a capacitance matching unit 430 according to an embodiment of the invention. Referring to FIG. 3 and FIG. 4, a difference between the capacitance matching unit 430 and the capacitance matching unit 330 is that the capacitance matching unit 430 further includes a switch unit 434. The switch unit 434 determines whether or not to couple the matching capacitor C_a to the sensing controller 120 according to a size selection signal s_sc, so as to transmit the driving signal s d to an input of the multiplexer 332 through the matching capacitor C_a. The size selection signal s_sc may be provided by the sensing controller 120, though the invention is not limited thereto.

In the present embodiment, the capacitance matching unit 430 can be also applied to the structure/configuration of the touch apparatus 300 of FIG. 3 to decrease the parasitic capacitance effect of the scan lines SCL_1-SCL_n. The switch unit 434 includes a first switch SW1 and a second switch SW2. A first terminal of the first switch SW1 is coupled to the sensing controller 120, and a second terminal thereof is coupled to a first terminal of the matching capacitor C_a. A first terminal of the second switch SW2 is coupled to the sensing controller 120 and the first terminal of the first switch SW1, and a second terminal thereof is coupled to (the input of) the multiplexer 332 and a second terminal of the matching capacitor C_a.

In other words, the capacitance matching unit 430 has two different signal paths according conducting states of the first switch SW1 and the second switch SW2, where when the first switch SW1 is turned on but the switch SW2 is turned off, the capacitance matching unit 430 decreases the parasitic capacitance effect according to the same method as that of the capacitance matching unit 330 of FIG. 3. When the second switch SW2 is turned on but the switch SW1 is turned off, the matching capacitor C_a is shorted, and the driving signal s_d is directly input to the input of the multiplexer 332 without passing through the matching capacitor C_a.

A designer can design/build a predetermined value corresponding to a certain predetermined size in the sensing controller 120 in advance according to the size of the touch panel 110, and the sensing controller 120 can learn the size of the touch panel 110 by reading the inbuilt predetermined value. In case that the sensing controller 120 learns the size of the touch panel 110, the sensing controller 120 can produce two complementary size selection signals s_sc and s_rsc to respectively control the first switch SW1 and the second switch SW2. When the first switch SW1 is turned on according to the size selection signal s_sc, the driving signal s_d is transmitted to the input of the multiplexer 332 through the matching capacitor C_a, so as to compensate the parasitic capacitance effect caused by wiring. In other words, the matching capacitor C_a is coupled to the sensing controller 120 such that the multiplexer 332 receives the driving signal s_d through the matching capacitor C_a, and the capacitance matching unit 430 is equivalent to the capacitance matching unit 330.

Comparatively, when the second switch SW2 is turned on according to the inverted size selection signal s_rsc, the driving signal s_d is directly transmitted to the input of the multiplexer 332 to stop compensating the parasitic capacitance effect caused by wiring. In other words, the sensing controller 120 drives the touch panel 110 through a general manner (i.e. the matching capacitor C_a is not used).

It should be noticed that in the present embodiment, the first switch SW1 and the second switch SW2 are respectively controlled by the size selection signal s_sc and the inverted size selection signal s_rsc, such that when the first switch SW1 is turned on, the second switch SW2 is correspondingly turned off, and when the first switch SW1 is turned off, the second switch SW2 is correspondingly turned on. However, in other embodiments, the first switch SW1 and the second switch SW2 can be respectively an N-type transistor and a P-type transistor, such that one of the first switch SW1 and the second switch SW2 can be selectively turned on according to the same size selection signal s_sc, though the invention is not limited thereto.

Moreover, in the present embodiment, the switch unit 434 is implemented by using the first switch SW1 and the second switch SW2. However, in other embodiments, the switch unit 434 may have different implementation designs, for example, a switch coupled between the multiplexer 332 and the matching capacitor C_a is switched to couple the matching capacitor C_a to the input of the multiplexer 332 or directly couple the sensing controller 120 to the input of the multiplexer 332 according to the size selection signal s_sc, which is not limited by the invention.

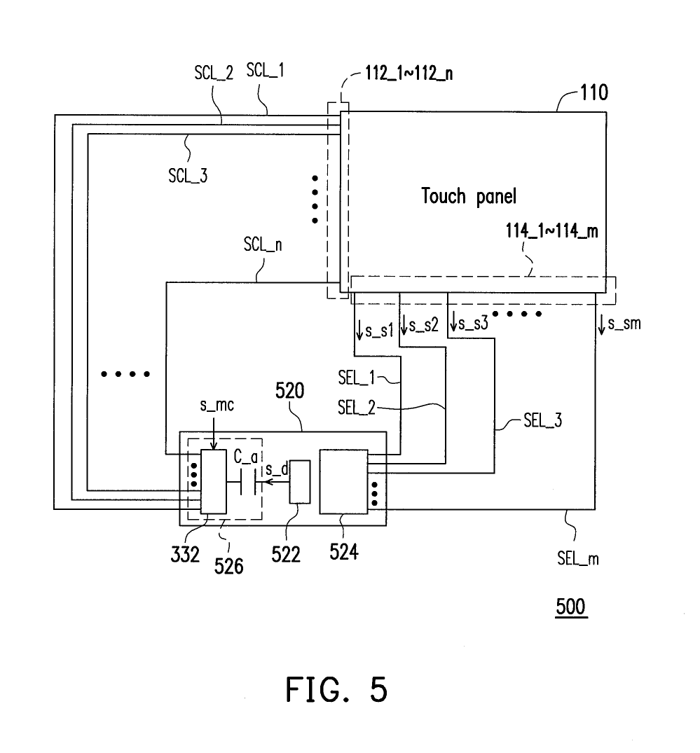

FIG. 5 is a schematic diagram of a touch apparatus 500 according to an embodiment of the invention. In the present embodiment, in order to decrease wiring layout complexity of the touch apparatus, a capacitance matching unit 526 is further designed in a sensing controller 520. Referring to FIG. 5, the touch apparatus 500 includes the touch panel 110 and the sensing controller 520. The sensing controller 520 includes a driving module 522, a sensing module 524 and the capacitance matching unit 526. Functions of the driving module 522 and the sensing module 524 are the same as that described above, which are not repeated.

The capacitance matching unit 526 is similar to the capacitance matching unit 330 of the embodiment of FIG. 3, which includes the multiplexer 332 and the matching capacitor C_a, and functions of the multiplexer 332 and the matching capacitor C_a are as that described above. A difference between the capacitance matching unit 526 and the capacitance matching unit 330 is that the capacitance matching unit 526 is embedded in the sensing controller 520. Further, the designer can integrate the capacitance matching unit 526 into the sensing controller 520 according to a method of integrated circuit (IC) layout, so as to decrease wiring complexity of the scan lines SCL_1-SCL_n between the touch panel 110 and the sensing controller 520 of the touch apparatus 500.

Since the sensing controller 520 sequentially outputs the driving signal s_d to the corresponding scan lines SCL_1-SCL_n to drive the touch panel 110 by using the multiplexer 332 and the multiplexing control signal s_mc, in an actual application, it is only required to additionally dispose the matching capacitor C_a between the multiplexer 332 and the driving module 522, and the driving module 522 outputs the driving signal s_d to the input of the multiplexer 332 through the matching capacitor C_a. In this way, the structure of the capacitance matching unit 526 is implemented to reduce the parasitic capacitance effect on wiring.

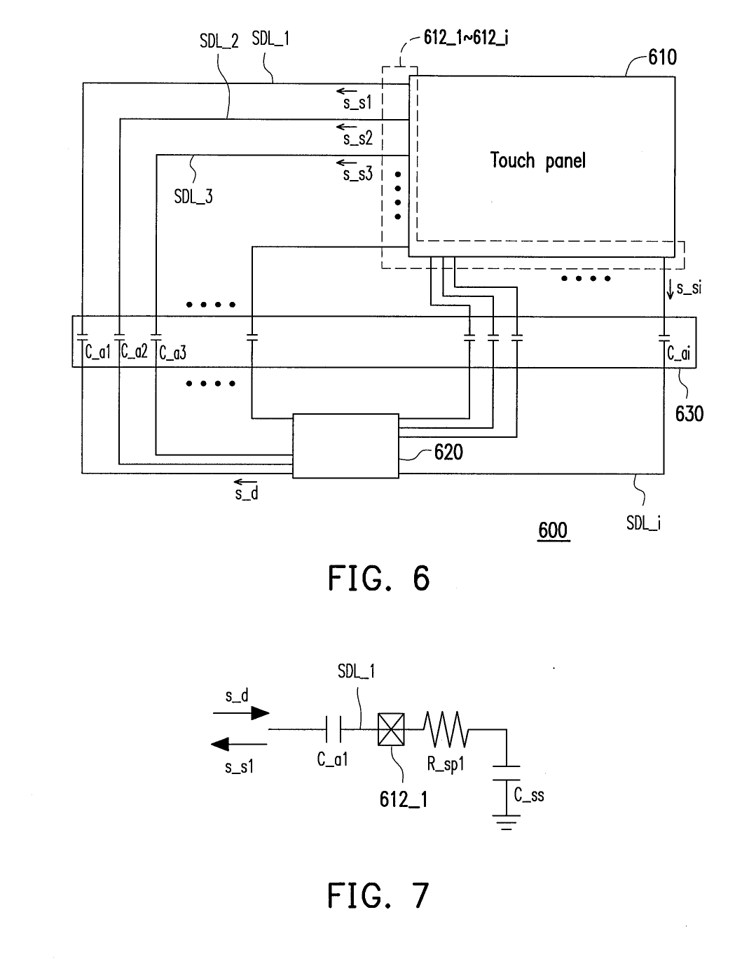

FIG. 6 is a schematic diagram of a touch apparatus 600 according to an embodiment of the invention. Referring to FIG. 6, the touch apparatus 600 includes a touch panel 610, a sensing controller 620 and a capacitance matching unit 630. The touch panel 610 has a plurality of driving sensing ports 612_1-612_i, where the touch panel 610 outputs a plurality of sensing signals s_s1_-s_si through the driving sensing ports 612_1-612_i, and i is a positive integer. The sensing controller 620 outputs a driving signal s_d to drive the touch panel 610 through a plurality of driving sensing lines SDL_1-SDL_i coupled to the driving sensing ports 612 _1-612i, and receives the sensing signals s_s1-s_si through the driving sensing lines SDL_1-SDL_i. The capacitance matching unit 630 is coupled between the touch panel 610 and the sensing controller 620 through the driving sensing lines SDL_1-SDL_i. The capacitance matching unit 630 is used for tuning an equivalent capacitance of the touch panel 610.

In the present embodiment, the touch panel 610 is, for example, a self capacitance touch panel, in which capacitance variations respectively between each corresponding electrode and ground in the touch panel 610 are sensed to output the sensing signals s_s1-s_si. In the self capacitance touch apparatus 600, the touch panel 610 receives the driving signal s_d through the driving sensing ports 612_1-612_i, and transmits back the sensing signals s_s1-s sm also via the driving sensing ports 612_1-612_i to determine a touch operation of the user on the touch panel 110, for example, a touch position or a touch gesture, etc., so as to generate touch information of the touch panel.

Moreover, the capacitance matching unit 630 of the present embodiment, for example, includes a plurality of matching capacitors C_a1-C_ai. First terminals of the matching capacitors C_a1-C_ai are coupled to the sensing controller 620, and second terminals of the matching capacitors C_a1-C_ai are correspondingly coupled to the driving scan lines SDL_1-SDL_i. In other words, the matching capacitors C_a1-C_ai are correspondingly connected in series to the driving sensing lines SDL_1-SDL_i. Capacitances of the matching capacitor C_a1-C_ai are determined by a size of the touch panel 610.

Compared to the touch panel 110 of the embodiment of FIG. 1, since the self capacitance touch panel 610 determines whether the touch panel 610 is subjected to a touch operation by sensing self capacitance between the electrodes, sensing channels in the self capacitance touch panel 610 are also readout channels. Moreover, after the sensing channels of the touch panel 610 are driven by the driving signal, the touch panel 610 also outputs the sensing signals s_s1-s_si through the sensing channels. In other words, the driving sensing lines SDL_1-SDL_i are coupled to the corresponding sensing channels (readout channels) through the driving sensing ports 612 1-612i, and the touch apparatus 600 performs signal transmission between the touch panel 610 and the sensing controller 620 through the driving sensing lines SDL_1-SDL_i.

In the present embodiment, the sensing controller 620 outputs the driving signal s_d to drive the touch panel 610 through the matching capacitors C_a1-C_ai and the corresponding driving sensing lines SDL_1-SDL_i. Then, the touch panel 610 transmits back the corresponding sensing signals s_s1-s_si to the sensing controller 620 for signal processing through the driving sensing lines SDL_1-SDL_i. Therefore, the touch apparatus 600 can decrease the equivalent capacitance of the touch panel 610 through the matching capacitors C_a1-C_ai connected in series to the driving sensing lines SDL_1-SDL_i.

FIG. 7 is a schematic diagram of an equivalent circuit between the touch panel 610 and the sensing controller 620 of the embodiment of FIG. 6. Referring to FIG. 7, taking the equivalent circuit of the driving sensing port 612_1 as an example, before the capacitance matching unit 630 is added, a circuit characteristic model between the touch panel 610 and the sensing controller 620 can be equivalent to a resistor R_sp1 and a capacitor C_ss. The resistor R_sp1 is an equivalent resistor of the driving sensing port 612_1 (including a resistance of the electrode and a parasitic resistance of the driving sensing line SDL_1), the capacitor C_ss is a self capacitor of the driving sensing port 612_1, i.e. a capacitor between the electrode and ground.

In detail, when the touch panel 110 is a large size capacitive touch panel, due to an influence of a wiring effect, a parasitic capacitance of the diving sensing line SDL_1 may result in a fact that the capacitance of the capacitor C_ss is rather large and the touch panel 110 is hard to be driven. Therefore, the capacitance matching unit 630 is added to resolve the above problem. In FIG. 7, by adding the capacitance matching unit 630, the matching capacitor C_ai is connected to the driving sensing line SDL_1 in series, which decreases a whole equivalent capacitance. Therefore, compared to a general touch apparatus, the touch apparatus 100 of the present embodiment can still drive a large size self capacitance touch panel without changing the driving capability of the driving signal s_d. Moreover, since excessively large self capacitance results in a fact that the touch panel is hard to be driven, and excessively small self capacitance results in a fact that the sensing signals output by the touch panel are distorted, the value of the matching capacitors C_a1-C_ai are required to be adjusted according to the size of the touch panel 610.

In summary, in the touch apparatus of the invention, the capacitance matching unit connected in series to the lines is used to decease a parasitic capacitance effect between the touch panel and the sensing controller. Therefore, the sensing controller can drive a large size touch panel without changing driving capability of the driving signal. Moreover, the capacitance matching unit can also be directly configured in the circuit of the sensing controller to decrease wiring complexity of the touch apparatus.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A touch apparatus, comprising:
a touch panel, having a plurality of scan ports and a plurality of sensing ports, wherein the touch panel outputs a plurality of sensing signals through the sensing ports;
a sensing controller, driving the touch panel through a plurality of scan lines correspondingly coupled to the scan ports, and receiving the sensing signals through a plurality of sensing lines correspondingly coupled to the sensing ports; and
a capacitance matching unit, coupled between the touch panel and the sensing controller through the scan lines, and configured to tune an equivalent capacitance of the touch panel.

2. The touch apparatus as claimed in claim 1, wherein the sensing controller comprises:
a driving module, providing a driving signal, and sequentially outputting the driving signal to the touch panel through the scan lines; and
a sensing module, receiving the sensing signals through the sensing lines, and generating touch information of the touch panel according to the sensing signals.

3. The touch apparatus as claimed in claim 1, wherein the capacitance matching unit comprises:
a plurality of matching capacitors, each having a first terminal and a second terminal, the first terminals of the matching capacitors being coupled to the sensing controller, and the second terminal of each of the matching capacitors being correspondingly coupled to one of the scan lines, wherein capacitances of the matching capacitors are positively correlated to a size of the touch panel.

4. The touch apparatus as claimed in claim 1, wherein the capacitance matching unit comprises:
a matching capacitor, having a first terminal and a second terminal, wherein the first terminal of the matching capacitor is coupled to the sensing controller; and
a multiplexer, having an input and an output, wherein the input of the multiplexer is coupled to the second terminal of the matching capacitor, and the output of the multiplexer is coupled to each of the scan lines,
wherein a capacitance of the matching capacitor is determined by a size of the touch panel, and the multiplexer couples the matching capacitor to one of the scan lines according to a multiplexing control signal.

5. The touch apparatus as claimed in claim 4, wherein the capacitance matching unit further comprises:
a switch unit, determining whether or not to couple the matching capacitor to the sensing controller according to a size selection signal, wherein the switch unit comprises:
a first switch, having a first terminal and a second terminal, wherein the first terminal of the first switch is coupled to the sensing controller, and the second terminal of the first switch is coupled to the first terminal of the matching capacitor; and
a second switch, having a first terminal and a second terminal, wherein the first terminal of the second switch is coupled to sensing controller and the first terminal of the first switch, and the second terminal of the second switch is coupled to the multiplexer and the second terminal of the matching capacitor,
wherein when the size of the touch panel is greater than a predetermined value, the first switch is turned on according to the size selection signal, and the second switch is turned off according to the size selection signal, and when the size of the touch panel is smaller than the predetermined value, the first switch is turned off according to the size selection signal, and the second switch is turned on according to the size selection signal.

6. A touch apparatus, comprising:
a touch panel, having a plurality of scan ports and a plurality of sensing ports, wherein the touch panel outputs a plurality of sensing signals through the sensing ports; and
a sensing controller, driving the touch panel through a plurality of scan lines correspondingly coupled to the scan ports, and receiving the sensing signals through a plurality of sensing lines correspondingly coupled to the sensing ports,
wherein the sensing controller is further configured to tune an equivalent capacitance of the touch panel.

7. The touch apparatus as claimed in claim 6, wherein the sensing controller comprises:
a driving module, providing a driving signal, and sequentially outputting the driving signal to the touch panel through the scan lines; and
a sensing module, receiving the sensing signals through the sensing lines, and generating touch information of the touch panel according to the sensing signals.

8. The touch apparatus as claimed in claim 6, wherein the sensing controller comprises:
a capacitance matching unit, coupled to the touch panel through the scan lines, wherein the capacitance matching unit sequentially outputs the driving signal to the corresponding scan lines, and tunes the equivalent capacitance of the touch panel.

9. The touch apparatus as claimed in claim 8, wherein the capacitance matching unit comprises:
a matching capacitor, having a first terminal and a second terminal, wherein the first terminal of the matching capacitor receives the driving signal; and
a multiplexer, having an input and an output, wherein the input of the multiplexer is coupled to the second terminal of the matching capacitor, and the output of the multiplexer is coupled to each of the scan lines,
wherein the multiplexer couples the matching capacitor to one of the scan lines according to a multiplexing control signal, so that the driving signal is sequentially output to the touch panel through each of the scan lines coupled to the matching capacitor.

10. A touch apparatus, comprising:
a touch panel, having a plurality of driving sensing ports, wherein the touch panel outputs a plurality of sensing signals through the driving sensing ports;
a sensing controller, outputting a driving signal to drive the touch panel through a plurality of driving sensing lines coupled to the driving sensing ports, and receiving the sensing signals through the driving sensing lines; and
a capacitance matching unit, coupled between the touch panel and the sensing controller through the driving sensing lines, and configured to tune an equivalent capacitance of the touch panel.

11. The touch apparatus as claimed in claim 10, wherein the capacitance matching unit comprises:
a plurality of matching capacitors, each having a first terminal and a second terminal, the first terminals of the matching capacitors being coupled to the sensing controller, and the second terminal of each of the matching capacitors being correspondingly coupled to one of the driving scan lines, wherein capacitances of the matching capacitors are positively correlated to a size of the touch panel.
